(19) United States
(12) Patent Application Publication
(10) Pub. No.: US 2004/0017344 A1
(43) Pub. Date: Jan. 29, 2004

(54) Liquid-crystal display device and driving method thereof

(76) Inventor: Takahiro Takemoto, Tokyo (JP)

Correspondence Address: KATTEN MUCHIN ZAVIS ROSENMAN, 575 MADISON AVENUE, NEW YORK, NY, 10022-2585, US

(21) Appl. No.: 10/625,091

(22) Filed: Jul. 22, 2003

(30) Foreign Application Priority Data
Jul. 25, 2002 (JP) 216252/2002

(51) Int. Cl. G09G 3/36

(52) U.S. Cl. 345/87

(57) ABSTRACT

An active-matrix addressing LCD device prevents the formation of unwanted horizontal stripes without decreasing the luminance. The polarity of a data voltage applied to each of the pixels by way of a corresponding one of the data lines and a corresponding one of the TFTs is inverted in every set of two or more horizontal synchronizing periods (e.g., the 2-H dot or line inversion method). The source driver has a resetting means for resetting the data voltages outputted by the source driver circuit in the blanking period of each of the horizontal synchronizing periods. The source driver may have a polarity-inverting means for inverting the polarity of the data voltages outputted by the source driver circuit in the blanking period of each of the horizontal synchronizing periods. The data voltages in each of the horizontal synchronizing periods can be uniform in their rising states.

### BACKGROUND OF THE INVENTION

1. Field of the Invention

The present invention relates to a liquid-crystal display (LCD) device and a driving method thereof. More particularly, the invention relates to an active-matrix addressing LCD device and a method of driving the device, in which the polarization of the data or signal voltage applied to each pixel is inverted in every two or more horizontal synchronization periods.

2. Description of the Related Art

In recent years, the well-known active-matrix addressing LCD device, which uses Thin-Film Transistors (TFTs) as its switching elements, has been extensively used as the display device for so-called. Office Automation (OA) instruments, mobile communication terminals, mobile information-processing devices, and so on. This is because the active-matrix addressing LCD device has an advantage that its body is thin and light-weight and its power-consumption is comparatively low.

The active-matrix addressing LCD device comprises a set of pixels arranged in a matrix array, TFTs (i.e., switching elements) arranged for the respective pixels, a gate driver circuit (which may be termed a vertical or column driver), a source driver circuit (which may be termed a horizontal or row driver), and a controller circuit for controlling the gate and source drivers. The pixels and the TFTs are formed on the active-matrix substrate made of glass.

The gate driver circuit successively supplies a selection or scanning signal (i.e., a selection or scanning voltage) to the gates of the TFTs aligned in the respective rows of the pixel matrix through the corresponding scanning or gate lines, thereby successively selecting the pixels in the respective rows of the pixel matrix. The source driver circuit supplies data signals (i.e., data voltages) to the respective pixels by way of their corresponding TFTs through their corresponding data or source lines.

A common electrode is formed on the opposite substrate made of glass. A liquid-crystal layer is sandwiched by the active-matrix substrate and the opposite substrate.

When the TFT for the pixel is turned on by the selection voltage from the gate driver circuit, the data voltage from the source driver circuit is supplied to the pixel electrode of the said pixel by way of the corresponding source line and the said TFT. When the said TFT is turned off, the data voltage thus supplied is kept in the said pixel electrode. This means that the electric charge is stored in the liquid-crystal capacitor formed by the pixel electrode, the common electrode, and the liquid-crystal layer. Due to the electric field between the pixel electrode and the common electrode, the arrangement of the liquid crystal molecules is changed according to the data voltage in the pixel. The same operation is conducted for the other pixels. In this way, a desired image is displayed on the screen of the LCD device.

Typically, the selection voltage supplied from the gate driver circuit is a pulsed signal voltage having a pulse width equal to the “horizontal synchronizing period”. In the horizontal synchronizing period, all the TFTs connected to the said gate or scanning line are kept in the conducting (i.e., selected) state and therefore, the data voltages from the source driver circuit are applicable to the respective pixel electrodes connected to the said TFTs.

All the scanning lines are sequentially selected or driven one by one by the selection voltage within the “frame period”. Thereafter, all the scanning lines are selected again in the same way in the next “frame period”. Thus, the same selection operation is repeated during operation.

The active-matrix addressing LCD device is usually driven with an ac voltage of 60 Hz by using the known “frame inversion method”. In this method, the polarization of the data voltages applied to the respective pixel electrodes by way of the TFTs is inverted in every two adjoining frame periods. In other words, a positive voltage and a negative voltage, each of which corresponds to the data voltage, are alternatively applied to each pixel electrode in an every frame period while using the common voltage applied to the common electrode as the reference. This is to avoid the polarization of the liquid-crystal molecules and to prevent the image-quality degradation due to incidental images induced by the so-called ghosting.

It is ideal that the positive voltage waveform and the negative voltage waveform of the data voltage applied across the liquid crystal layer are symmetrical. However, due to deviation of the common voltage, impurities contained in the liquid crystal cells, and so on, such an ideal voltage waveform as above is unable to be actually applied. Thus, it is usual that the positive effective value and the negative effective value of the data voltage are different from each other. As a result, the obtainable optical transmittance of the liquid crystal layer by the positive effective voltage value is different from that by the negative effective voltage value, thereby fluctuating the luminance according to the frequency of the applied ac voltage. As described above, the active-matrix addressing LCD device is driven by the ac voltage of 60 Hz for the “frame inversion method”, a problem that unwanted flicker at 30 Hz will be observed due to the luminance fluctuation arises.

To suppress the unwanted 30 Hz flicker, improved driving methods such as the “dot inversion method” and the “line inversion method” have ever been developed. In these two methods, the polarization inversion of the applied data voltages is performed in every horizontal synchronizing period in which each of the gate lines is being selected.

With the “dot inversion method”, the polarization of the data voltages applied to the individual pixels (i.e., the sources of the individual TFTs) is inverted within every frame period in such a way that the voltage polarization of one of the pixels is opposite to that of the pixels adjoining horizontally and vertically to the said pixel. Thus, the polarization of the data voltages applied to the two adjoining pixels is opposite to each other within each frame both in the horizontal direction (along the scanning lines) and in the vertical direction (along the data lines).

On the other hand, with the “line inversion method”, the polarization of the data voltages applied to the individual pixels (i.e., the sources of the individual TFTs) is inverted within every frame period in such a way that the voltage polarization of the pixels connected to one of the scanning lines is opposite to that of the pixels connected to another scanning line adjoining thereto. Thus, the polarization of the data voltages applied to the pixels by way of the adjoining scanning lines is opposite to each other within each frame in the vertical direction (along the data lines).

FIG. 3 schematically shows the conventional dot inversion method described above, in which the reference symbols G1, G2, and G3 denote respectively the first, second, and third gate or scanning lines, and the reference symbols S1, S2, S3, S4, and S5 denote respectively the first, second, third, fourth, and fifth source or data lines. As seen from FIG. 3, the polarity of the data voltages applied to the individual pixels is inverted horizontally and vertically within every frame period, where as the polarization inversion period is equal to the frame period. In this method, even if the effective values of the applied positive and negative data voltages within the first and second frames are different from each other, the effective value difference is spatially cancelled to suppress the 30-Hz flicker. This method has an advantage that the quality of images itself is improved, because the fluctuation of the common voltage (i.e., the voltage applied to the common electrode) induced by way of the source lines is reduced.

The conventional dot inversion method shown in FIG. 3 fully exhibits its flicker canceling effect with respect to a uniform gray image displayed in the whole screen. However, this method scarcely exhibits its effect for some images having specific patterns (e.g., a fixed pattern displayed in an area where the polarization of the applied data voltages to the pixels is inverted). This means that flicker will be observed because the polarity of the applied data voltages is biased for the images in question. Therefore, the dot inversion method of FIG. 3 is weak in displaying a checkered pattern image formed by dots.

Because of the same reason as above, the conventional line inversion method (not shown) is weak in displaying a striped pattern image formed by horizontal stripes arranged at every other line.

These weak images scarcely appear when animation is displayed on the screen. However, a checkered pattern of dots frequently appears in the ending scene of the Microsoft Windows (Registered Trademark) or in images formed by dithering or gradation. Therefore, these weak images are often observed in the personal computer screen and as a result, there is the need to solve this problem.

To solve this problem, instead of the above-described conventional dot and line inversion methods where the polarization inversion of the applied data voltages is performed in every horizontal synchronizing period, improved methods have been developed. In these improved methods, the polarization inversion of the applied data voltages is carried out in every “two” horizontal synchronizing periods (i.e., the polarization inversion period is equal to two successive horizontal synchronizing periods). These improved methods may be termed simply the “2-H inversion methods” hereinafter. Here, the “2-H dot inversion method” and the “2-H line inversion method” are explained.

FIGS. 4 and 5 schematically show the 2-H dot inversion method and the 2-H line inversion method, respectively. By using these two methods, flicker is effectively prevented in the weak checkered pattern appearing in the ending scene of the Windows. On the other hand, the said weak checkered pattern rarely appears in the images formed by dithering or gradation and as a result, flicker is suppressed more effectively as a whole than the above-described conventional dot and line inversion methods.

However, the above-described 2-H dot and line inversion methods shown in FIGS. 4 and 5 have the following problem.

Specifically, the first one of the two horizontal synchronizing periods (i.e., the polarization inversion period) includes the charging period for electrically charging the drain lines while the second one of the same does not include such the charging period. Therefore, the total amount of electric charge written into the corresponding pixels within the first horizontal synchronizing period is likely to be less than that written into the corresponding pixels within the second horizontal synchronizing period, if the length of the charging or writing period is insufficient. The difference of the total amount of written electric charge between the first and second horizontal synchronizing periods induces luminance difference between the said periods. As a result, a problem that unwanted horizontal stripes appear in every polarization inversion period occurs. This problem will be explained in detail below with reference to FIG. 1.

FIG. 1 shows a waveform diagram of the output signal of the so-called source or horizontal driver circuit. In FIG. 1, the reference symbol STB denotes the pulsed latch signal for temporarily latching the data in the source driver circuit, VCK denotes the pulsed clock signal, and VOE denotes the pulsed enable signal for controlling the operation of the writing gates in the source driver circuit. The latch signal STB and the enable signal VOE are synchronized with the clock signal VCK.

As shown in FIG. 1, the “writing period T_{WR}” is given by the time in which the enable signal VOE is in its low (L) level within the horizontal synchronizing period T_{HSYN} from the falling edge of the enable signal VOE to its next falling edge. The “blanking period T_{B}” is given by the time in which the enable signal VOE is in its high (H) level within the same horizontal synchronizing period T_{HSYN}.

As seen from FIG. 1, for example, the rising part of the output signal of the source driver circuit is included in the writing period T_{WR} of the first horizontal synchronizing period T_{HSYN} for the first gate line G1. On the other hand, no such rising part is included in the writing period T_{WR} of the second horizontal synchronizing period T_{HSYN} for the second gate line G2. Therefore, the total amount of the charge written into the respective pixels connected to the first gate line G1 is likely to be less than that written into the respective pixels connected to the second gate line G2, thereby generating luminance difference between the first and second gate lines G1 and G2. As a result, an unwanted horizontal stripe is generated between the gate lines G1 and G2 in the first polarization inversion period (=2T_{HSYN}).

The same explanation is applicable to the third and fourth gate lines G3 and G4 in the second polarization inversion period (=2T_{HSYN}), and the other gate lines in the third and subsequent polarization inversion periods. Thus, unwanted horizontal stripes are generated in the second and subsequent polarization inversion periods (=2T_{HSYN}), respectively.

To prevent the formation of the unwanted horizontal stripes, for example, an improved method shown in FIG. 2 was developed. With the improved method of FIG. 2, the writing period T_{WR} is shortened by adding the non-writing period T_{N} to each of the first and second horizontal synchronizing periods T_{HSYN} by way of the enable signal VOE. Thus, the total amounts of the written charge in the first and second horizontal synchronizing periods T_{HSYN} of every polarization inversion period are equalized to each other.

In the improved method of FIG. 2, the unwanted horizontal stripes are prevented. However, the writing period T_{WR} itself is shortened by addition of the non-writing period T_{N}. Thus, there is a problem that the total luminance is likely to decrease in the normally-black LCD panel where the active-matrix addressing LCD device is used.

### SUMMARY OF THE INVENTION

Accordingly, an object of the present invention is to provide an active-matrix addressing. LCD device that prevents the formation of unwanted horizontal stripes without decreasing the luminance, and a method of driving the device.

Another object of the present invention is to provide an active-matrix addressing LCD device that makes it possible to decrease the frequency or possibility of flicker even when the backlight intensity is high, and a method of driving the device.

The above objects together with others not specifically mentioned will become clear to those skilled in the art from the following description.

According to a first aspect of the present invention, an active-matrix addressing LCD device is provided, which comprises:

a panel including an active-matrix substrate, an opposite substrate, and a liquid crystal layer sandwiched by the active-matrix substrate and the opposite substrate;

the active-matrix substrate having data lines, scanning lines that intersect with the data lines at intersections, pixels arranged near the respective intersections, and TFTs arranged as switching elements for the respective pixels;

a source driver circuit for driving the data lines;

a gate driver circuit for driving the scanning lines; and

a controller circuit for controlling the source driver and the gate driver;

wherein a polarity of a data voltage applied to each of the pixels by way of a corresponding one of the data lines and a corresponding one of the TFTs is inverted in every set of two or more horizontal synchronizing periods by the controller circuit;

and wherein the source driver has a resetting means for resetting the data voltages outputted by the source driver circuit in a blanking period of each of the horizontal synchronizing periods of the set.

With the device according to the first aspect of the present invention, a polarity of a data voltage applied to each of the pixels by way of a corresponding one of the data lines and a corresponding one of the TFTs is inverted in every set of two or more horizontal synchronizing periods. The set of the two or more horizontal synchronizing periods is the polarity inversion period of the data voltages.

Moreover, the source driver has a resetting means for resetting the data voltages outputted by the source driver circuit in a blanking period of each of the horizontal synchronizing periods of the set.

Therefore, the data voltages applied to the corresponding pixels in each of the horizontal synchronizing periods of the set can be uniform in their rising states by the resetting operation. This means that the total amount of the charge written into the pixels in a first one of the two or more horizontal synchronizing periods of every polarization inversion period can be equalized to that of the charge written into the pixels in a second or subsequent one of the same horizontal synchronizing periods. As a result, the unwanted horizontal stripes, which are caused by the luminance difference between the first one and the second or subsequent one of the horizontal synchronizing periods of every polarization inversion period, are prevented.

Furthermore, unlike the prior-art method of FIG. 2, the writing period T_{WR} is not shortened by addition of the non-writing period T_{N}. Therefore, the luminance is not decreased.

In addition, since the unwanted horizontal stripes are prevented by resetting the data voltages outputted by the source driver circuit in the blanking period of each of the horizontal synchronizing periods of the set, the frequency or possibility of flicker itself is reduced. Thus, flicker is rarely observed even when the backlight intensity is high.

In a preferred embodiment of the device according to the first aspect of the invention, the resetting means performs its resetting operation with reference to a latch signal supplied to the source driver circuit by the controller circuit.

In another preferred embodiment of the device according to the first aspect of the invention, each of the data voltages alternately has a positive value or a negative value in the polarity inversion period (i.e., the set of the two or more horizontal synchronizing periods). The resetting means is controlled in such a way that each of the data voltages will reach a middle point value between the positive value and the negative value after the resetting operation is completed.

In still another preferred embodiment of the device according to the first aspect of the invention, the polarity of the data voltages supplied by way of the data lines is alternately inverted in every set of the two horizontal synchronizing periods and in every vertical synchronizing period within every frame period. Thus, the device is driven by a 2-H dot inversion method.

In a further preferred embodiment of the device according to the first aspect of the invention, the polarity of the data voltages supplied by way of the data lines is alternately inverted in every set of the two horizontal synchronizing periods within every frame period. Thus, the device is driven by a 2-H line inversion method.

According to a second aspect of the present invention, another active-matrix addressing LCD device is provided, which comprises:

a panel including an active-matrix substrate, an opposite substrate, and a liquid crystal layer sandwiched by the active-matrix substrate and the opposite substrate;

the active-matrix substrate having data lines, gate lines that intersect with the data lines at intersections, pixels arranged near the respective intersections, and TFTs arranged as switching elements for the respective pixels;

a source driver circuit for driving the data lines;

a gate driver circuit for driving the scanning lines; and

a controller circuit for controlling the source driver and the gate driver;

wherein a polarity of a data voltage applied to each of the pixels by way of a corresponding one of the data lines and a corresponding one of the TFTs is inverted in every, set of two or more horizontal synchronizing periods by the controller circuit;

and wherein the source driver has a polarity inverting means for inverting the polarity of the data voltages outputted by the source driver circuit in a blanking period of each of the horizontal synchronizing periods of the set.

With the device according to the second aspect of the present invention, similar to the device according to the first aspect, a polarity of a data voltage applied to each of the pixels by way of a corresponding one of the data lines and a corresponding one of the TFTs is inverted in every set of two or more horizontal synchronizing periods. The set of the twp or more horizontal synchronizing periods is the polarity inversion period of the data voltages.

Moreover, the source driver has a polarity inverting means for inverting the polarity of the data voltages outputted by the source driver circuit in a blanking period of each of the horizontal synchronizing periods of the set.

Therefore, the data voltages applied to the corresponding pixels in each of the horizontal synchronizing periods of the set can be uniform in their rising states by the polarity inverting operation. This means that the total amount of the charge written into the pixels in a first one of the two or more horizontal synchronizing periods of every polarization inversions period can be equalized to that of the charge written into the pixels in a second or subsequent one of the same horizontal synchronizing periods. As a result, the unwanted horizontal stripes, which are caused, by the luminance difference between the first one and the second or subsequent one of the horizontal synchronizing periods of every polarization inversion period, are prevented.

Furthermore, unlike the prior-art method of FIG. 2, the writing period T_{WR} is not shortened by addition of the non-writing period T_{N}. Therefore, the luminance is not decreased.

In addition, since the unwanted horizontal stripes are prevented by polarity-inverting the data voltages outputted by the source driver circuit in the blanking period of each of the horizontal synchronizing periods of the set, the frequency or possibility of flicker itself is reduced. Thus, flicker is rarely observed even when the backlight intensity is high.

In a preferred embodiment of the device according to the second aspect of the invention, the polarity inverting means performs its polarity-inverting operation with reference to a latch signal and a polarity-inverting signal, which are supplied to the source driver circuit by the controller circuit.

In another preferred embodiment of the device according to the second aspect of the invention, the polarity inverting means is controlled in such a way that each of the data voltages will reach a value of an opposite polarity after the polarity-inverting operation is completed.

In still another preferred, embodiment of the device according to the second aspect of the invention, the polarity of the data voltages supplied by way of the data lines is alternately inverted in every set of the two horizontal synchronizing periods and in every vertical synchronizing period within every frame period. Thus, the device is driven by a 2-H dot inversion method.

In a further preferred embodiment of the device according to the second aspect of the invention, the polarity of the data voltages supplied by way of the data lines is alternately inverted in every set of the two horizontal synchronizing periods within every frame period. Thus, the device is driven by a 2-H line inversion method.

According to a third aspect of the present invention, a method of driving an active-matrix addressing LCD device is provided. The device comprises:

a panel including an active-matrix substrate, an opposite substrate, and a liquid crystal layer sandwiched by the active-matrix substrate and the opposite substrate;

the active-matrix substrate having data lines, scanning lines that intersect with the data lines at intersections, pixels arranged near the respective intersections, and TFTs arranged as switching elements for the respective pixels;

a source driver circuit for driving the data lines;

a gate driver circuit for driving the scanning lines; and

a controller circuit for controlling the source driver and the gate driver.

The method comprises:

inverting a polarity of a data voltage applied to each of the pixels by way of a corresponding one of the data lines and a corresponding one of the TFTs in every set of two or more horizontal synchronizing periods; and

resetting the data voltages outputted by the source driver circuit in a blanking period of each of the horizontal synchronizing periods of the set.

The method according to the third aspect of the present invention corresponds to the above-described device according to the first aspect of the invention. Therefore, the same advantages as those in the device of the first aspect are obtainable.

In a preferred embodiment of the method according to the third of the invention, an operation of resetting the data voltages is performed with reference to a latch signal supplied to the source driver circuit by the controller circuit.

In another preferred embodiment of the method according to the third aspect of the invention, each of the data voltages alternately has a positive value or a negative value in the polarity inversion period (i.e., the set of the two or more horizontal synchronizing periods). An operation of the resetting the data voltages is performed in such a way that each of the data voltages will reach a middle point value between the positive value and the negative value after the resetting operation is completed.

In still another preferred embodiment of the method according to the third aspect of the invention, the polarity of the data voltages supplied by way of the data lines is alternately inverted in every set of the two horizontal synchronizing periods and in every vertical synchronizing period within every frame period. Thus, the device is driven by a 2-H dot inversion method.

In a further preferred embodiment of the method according to the third aspect of the invention, the polarity of the data voltages supplied by way of the data lines is alternately inverted in every set of the two horizontal synchronizing periods within every frame period. Thus, the device is driven by a 2-H line inversion method.

According to a fourth aspect of the present invention, another method of driving an active-matrix addressing LCD device is provided. The device comprises:

a panel including an active-matrix substrate, an opposite substrate, and a liquid crystal layer sandwiched by the active-matrix substrate and the opposite substrate;

the active-matrix substrate having data lines, scanning lines that intersect with the data lines at intersections, pixels arranged near the respective intersections, and TFTs arranged as switching elements for the respective pixels;

a source driver circuit for driving the data lines;

a gate driver circuit for driving the scanning lines; and

a controller circuit for controlling the source driver and the gate driver.

The method comprises:

inverting a polarity of a data voltage applied to each of the pixels by way of a corresponding one of the data lines and a corresponding one of the TFTs in every set of two or more horizontal synchronizing periods; and

inverting the polarity of the data voltages outputted by the source driver circuit in a blanking period of each of the horizontal synchronizing periods of the set.

The method according to the fourth aspect of the present invention corresponds to the above-described devices according to the second aspect of the invention. Therefore, the same advantages as those in the device of the second aspect are obtainable.

In a preferred embodiment of the method according to the fourth of the invention, an operation of inverting the polarity of the data voltages is performed with reference to a latch signal and a polarity-inverting signal, which are supplied to the source driver circuit by the controller circuit.

In another preferred embodiment of the method according to the fourth of the invention, an operation of inverting the polarity of the data voltages is performed in such a way that each of the data voltages will reach a value of an opposite polarity after the polarity-inverting operation is completed.

In still another preferred embodiment of the method according to the fourth of the invention, the polarity of the data voltages supplied by way of the data lines is alternately inverted in every set of the two horizontal synchronizing periods and in every vertical synchronizing period within every frame period. Thus, the device is driven by a 2-H dot inversion method.

In a further preferred embodiment of the method according to the fourth aspect of the invention, the polarity of the data voltages supplied by way of the data lines is alternately inverted in every set of the two horizontal synchronizing periods within every frame period. Thus, the device is driven by a 2-H line inversion method.

### BRIEF DESCRIPTION OF THE DRAWINGS

In order that the present invention may be readily carried into effect, it will now be described with reference to the accompanying drawings.

FIG. 1 is a waveform diagram showing the change of the waveforms of the latch signal STB, the clock signal VCK, the enable signal VOE, and the output signal of the source driver circuit in a prior-art 2-H dot or line inversion method used for driving the active-matrix addressing LCD device.

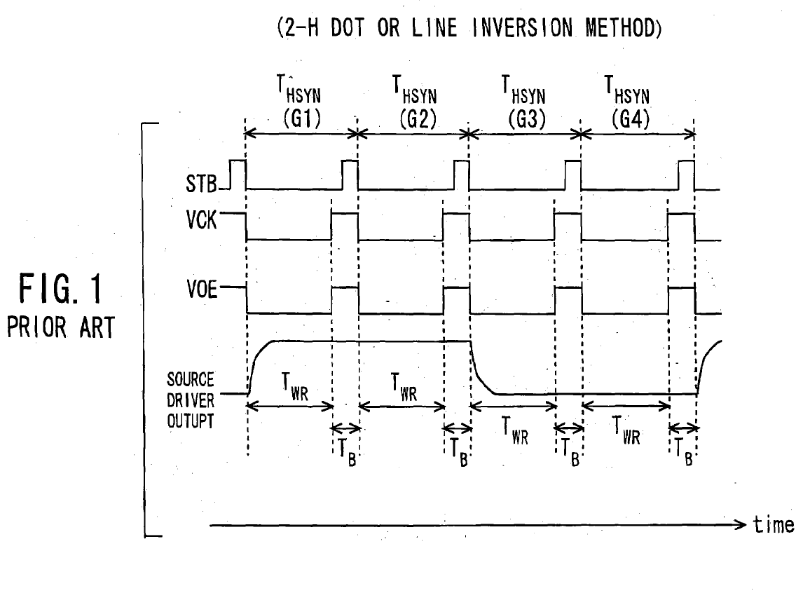

FIG. 2 is a waveform diagram showing the change of the waveforms of the enable signal VOE, and the output, signal of the source driver circuit in another prior-art 2-H dot or line inversion method used for driving the active-matrix addressing LCD device.

FIG. 3 is a schematic view of a part of the pixels showing the prior-art dot inversion method used for driving the active-matrix addressing LCD device.

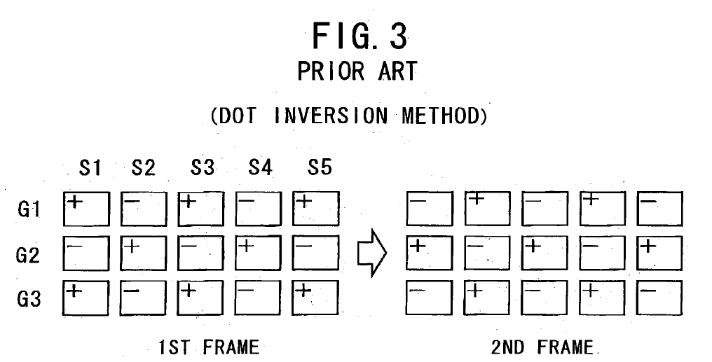

FIG. 4 is a schematic view of a part of the pixels showing the prior-art 2-H dot inversion method used for driving the active-matrix addressing LCD device.

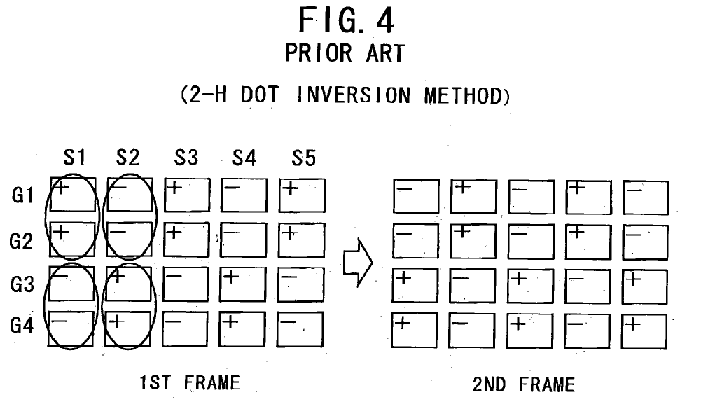

FIG. 5 is a schematic view of a part of the pixels showing the prior-art 2-H line inversion, method used for driving the active-matrix addressing LCD device,

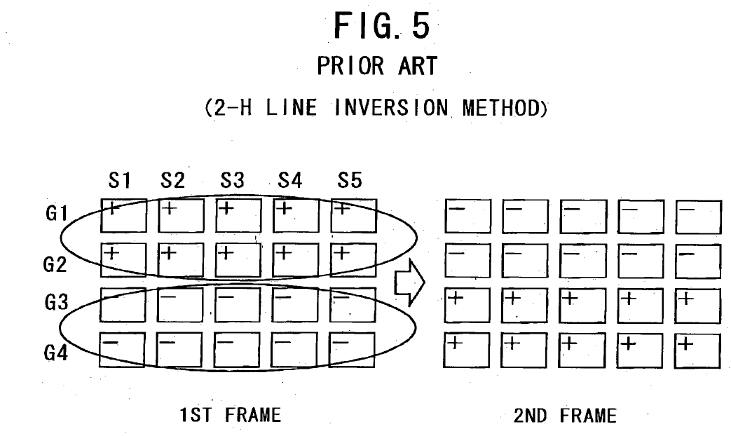

FIG. 6 is a schematic functional block diagram showing the circuit configuration of an active-matrix addressing LCD device according to a first embodiment of the invention.

FIG. 7 is a waveform diagram showing the change of the waveforms of the latch signal STB, the drain voltage of the TFT, and the gate voltages of the even- and odd-numbered gate lines in the LCD device according to the first embodiment of FIG. 6; in which the drain voltage of the TFT in the prior-art active-matrix addressing LCD device is additionally shown for comparison.

FIG. 8 is a waveform diagram showing the change of the waveforms of the latch signal STB, the polarization inverting signal POL, the drain voltage of the TFT, and the gate voltages of the even- and odd-numbered gate lines in an active-matrix addressing LCD device according to a second embodiment of the invention; in which the drain voltage of the TFT in the prior-art active-matrix addressing LCD device is additionally shown for comparison.

FIG. 9 is a waveform diagram showing the change of the waveforms of the latch signal STB, the clock signal VCK, the enable signal VOE, and the output signal of the source driver circuit in the active-matrix addressing LCD device according to the first embodiment of the invention.

FIG. 10 is a functional block diagram showing the configuration of the source driver circuit of the LCD device according to the first embodiment of the invention.

FIG. 11 is a functional block diagram showing the configuration of the source driver circuit of the LCD device according to the second embodiment of the invention.

### DETAILED DESCRIPTION OF THE PREFERRED EMBODIMENTS

Preferred embodiments of the present invention will he described in detail below while referring to the drawings attached.

### First Embodiment

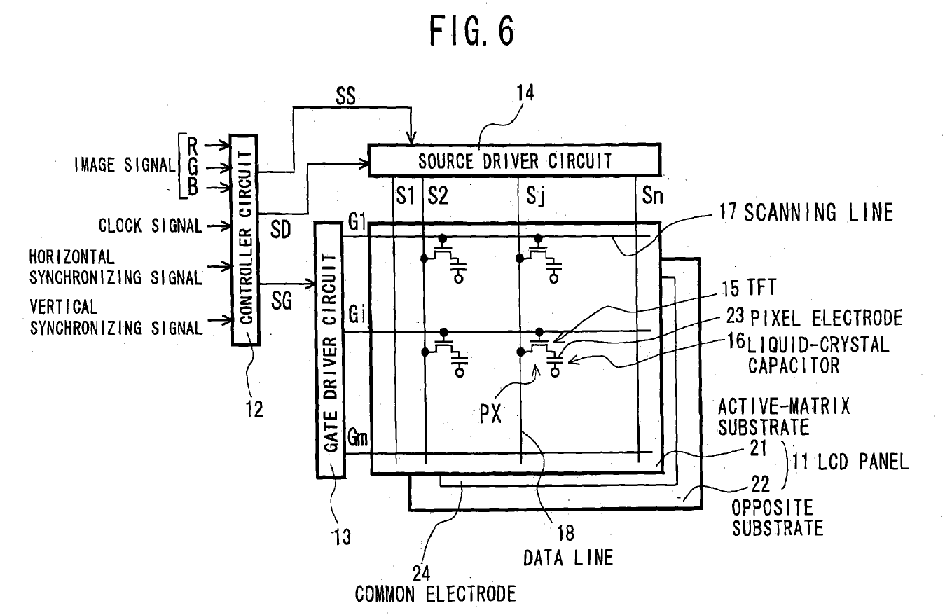

An active-matrix addressing LCD device according to a first embodiment of the invention has the circuit configuration shown in FIG. 6.

The LCD device of the first embodiment comprises a LCD panel 11, a controller circuit 12, a gate or vertical driver circuit 13, and a source or horizontal driver circuit 14.

The panel 11 has an active-matrix substrate 21, an opposite substrate 22, and a liquid crystal layer (not shown) sandwiched by the substrates 21 and 22. Each of the substrates 21 and 22 is made of transparent glass.

The active-matrix substrate 21 has first to m-th gate or scanning lines 17 (i.e., G1, . . . , Gi, . . . , Gm) extending horizontally, first to n-th source or data lines 18 (i.e., S1, . . . , Sj, . . . , Sn) extending vertically in such a way as to intersect perpendicularly with the scanning lines 17, pixels PX arranged in a matrix array near the respective intersections of the lines 17 and 18, and TFTs 15 arranged as switching elements for the respective pixels PX. Although not shown, storage capacitors for storing electric change are formed in the respective pixels PX.

The scanning lines 17 are electrically connected to the corresponding gate electrodes of the TFTs 15. The data lines 18 are electrically connected to the corresponding source electrodes of the TFTs 15. The drain electrodes of the TFTs 15 are electrically connected to the corresponding pixel electrodes 23 serving as the electrodes of corresponding liquid-crystal capacitors 16. The opposite electrodes of the capacitors 16 are constituted by a transparent common electrode 24 formed on the opposite substrate 22.

When the TFT, 15 for one of the pixels PX is turned on by the selection voltage from the gate driver circuit 13, the data voltage from the source driver circuit 14 is supplied to (i.e., written into) the pixel electrode 23 of the said pixel PX by way of the corresponding data line 18 and the said TFT 15. When the said TFT 15 is turned off, the data voltage thus supplied is kept in the said pixel electrode 23. This means that the electric charge is stored in the corresponding liquid-crystal capacitor 16. Due to the electric field between the pixel electrode 23 and the common electrode 24 of the capacitor 16, the arrangement of the liquid crystal molecules is changed according to the data voltage in the pixel PX. The same operation is conducted in the other pixels PX. In this way, desired images are displayed on the screen of the LCD device.

The controller circuit 12 receives R (red), G (green), and B (blue) image signals corresponding to the images to be displayed, a clock signal, a horizontal synchronizing signal, and a vertical synchronizing signal. The clock signal is used for synchronizing the operations of the gate driver circuit 13, the source driver circuit 14, and other circuits (not shown) in the LCD device. The horizontal and vertical synchronizing signals are used for controlling the scanning line selection operation of the gate driver circuit 13 and the data supply operation of the source driver circuit 14. Based on the image signals, the clock signal, and the horizontal and vertical synchronizing signals, the controller circuit 12 generates a gate driver control signal SG, a source driver control signal SS, and a data signal SD, and supplies them to the gate and source driver circuits 13 and 14.

The gate driver circuit 13 successively supplies the selection or scanning signals (i.e., selection or scanning voltages) to the gates of the TFTs 15 aligned in the respective rows of the pixel matrix through the corresponding scanning lines 17 based on the gate driver control signal SG. Thus, the pixels PX in the respective rows of the pixel matrix are successively selected or scanned.

The source driver circuit 14 supplies the data signals (i.e., data voltages) to the respective pixels PX by way of their corresponding TFTs 15 through their corresponding data lines 18 based on the source driver control signal SS. This operation is synchronized with the operation of the gate driver circuit 13. Thus, the images according to the R, G, and B image signals are displayed on the screen of the LCD device.

The selection voltage supplied from the gate driver circuit 13 is a pulsed signal voltage having a pulse width corresponding to the “horizontal synchronizing period”. In the horizontal synchronizing period, all the TFTs 15 connected to the said scanning line 17 are kept in the conducting (i.e., selected) state and therefore, the data voltages from the source driver circuit 14 are applied to the respective pixel electrodes 24 connected to the said TFTs 15.

All the scanning lines 17 are sequentially selected or driven one by one by the selection voltage within the “frame period”. Thereafter, all the scanning lines 17 are selected again in the same way in the next “frame period”. Thus, the same selection operation is always repeated during operation.

By the operations of the gate and source driver circuits 13 and 14 and the controller circuit 12, the polarity of the data voltage applied to each of the pixels PX by way of a corresponding one of the data lines 18 and a corresponding one of the TFTs 15 is inverted in every set of the two horizontal synchronizing periods. This means that the LCD device of the first embodiment is operated according to the “2-H dot inversion method” or the “2-H line inversion method”. Since the circuit configuration for realizing these two inversion methods are well known, explanation about the circuit configuration is omitted here.

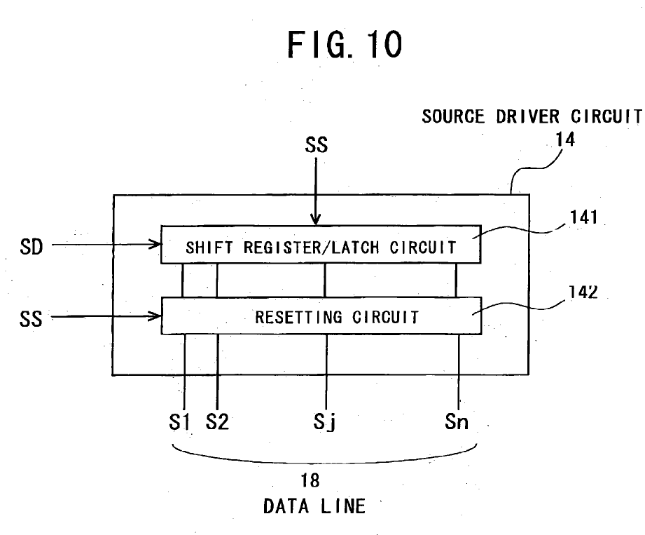

FIG. 10 schematically shows the circuit configuration of the source driver circuit 14. As seen from FIG. 10, the circuit 14 has a shift register/latch circuit 141 and a resetting circuit 142.

The shift register/latch circuit 141 has a function of a shift register for distributing the inputted image data SD to the respective data lines 18 (S1 to Sn) as the corresponding data voltages, and a function of a latch circuit for temporarily storing the inputted image data SD in the circuit 141.

The resetting circuit 142 has a function of resetting the data voltages to be outputted by the source driver circuit 14 in the blanking period of each horizontal synchronizing period in the polarity inversion period (i.e., the set of the two horizontal synchronizing periods).

The resetting operation of the resetting circuit 142 can be easily realized by inducing momentary electrical short-circuit among all the output terminals of the circuit 142. However, any other method may be used for this purpose.

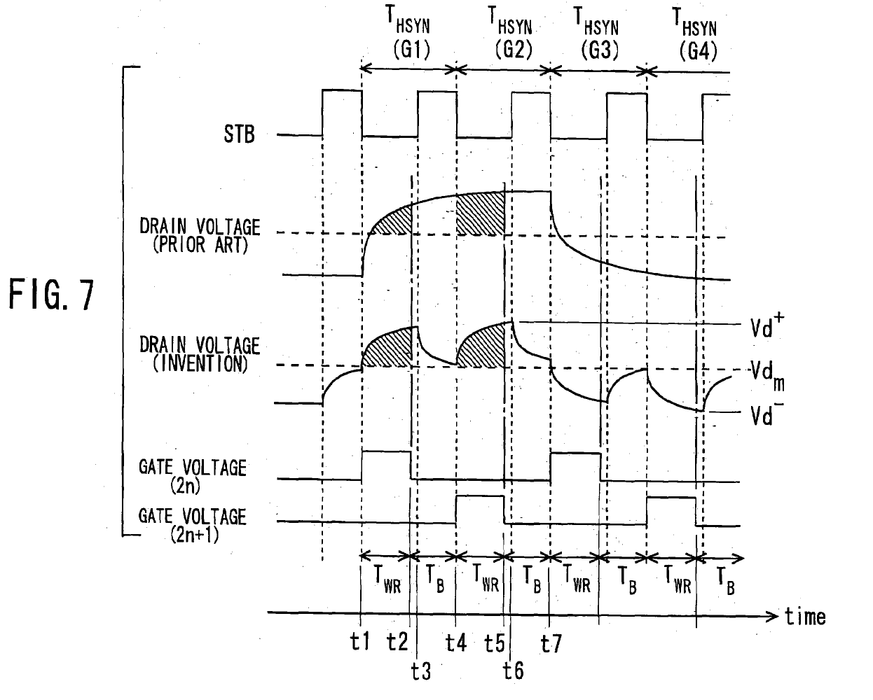

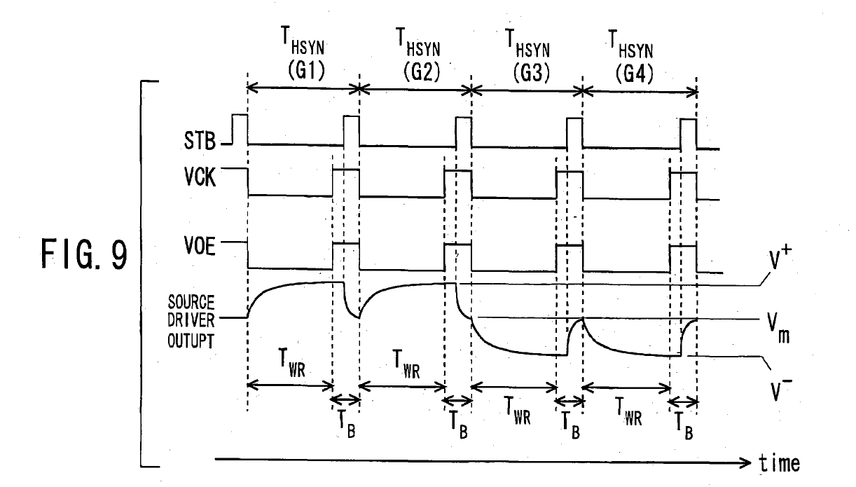

Next, the operation of the LCD device according to the first embodiment is explained in detail below with reference to FIGS. 7 and 9.

In FIGS. 7 and 9, STB denotes the pulsed latch signal, VCK denotes the clock signal, and VOE denotes the enable signal. At the falling edge t1 of the latch signal STB in the first horizontal synchronizing period T_{HSYN} for the scanning line G1, the latching operation of the shift register/latch circuit 141 is ended. Thus, the image data stored in the circuit 141 are supplied t6 the respective pixels PX by way of the data lines 18 (S1 to Sn). As a result, each of the output voltages of the source driver circuit 14 and the drain voltage of each TFT 15 start to increase gradually.

Thereafter, the latching operation is started at the rising edge t3 of the signal STB. This means that the image data in the shift register/latch circuit 141 is supplied to the pixels PX within the period from the time t1 to the time t3 in which the signal STB is kept in its low level (L). As a result, each of the output voltages of the source driver circuit 14 and the drain voltage of each TFT 15 increase gradually in the period from t1 to t3.

Subsequently, the latching operation thus started is ended at the next falling edge t4 of the signal STB. This means that the image data in the circuit 141 is latched within the period from the time t3 to the time t4 in which the signal STB is kept in its high level (H).

Similarly, at the falling edge t4 of the latch signal STB in the second horizontal synchronizing period T_{HSYN} for the gate or scanning line G2, the latching operation of the shift register/latch circuit 141 is ended. Thus, the image data stored in the circuit 141 are supplied to the respective pixels PX by way of the data lines 18 (S1 to Sn). Thereafter, the latching operation is started again at the next rising edge t6 of the signal STB and then, ended at the next falling edge t7 thereof.

The same operation as above is repeated in the third and fourth horizontal synchronizing periods T_{HSYN} for the scanning lines G3 and G4, respectively.

The data voltage outputted from the source driver circuit 14 has alternately a positive peak value V⁺ or a negative peak value V⁻ in every polarity inversion period (i.e., every set of the two horizontal synchronizing periods (=2T_{HSYN})), as shown in FIG. 9. The middle point value between the positive and negative peak values V⁺ and V⁻ is Vₘ. As a result, the drain voltage of the TFT 15, which is generated by the data voltage from the circuit 14, has alternately a positive peak value Vd⁺ or a negative peak value Vd⁻ in every polarity inversion period, as shown in FIG. 7. The middle point value between the positive and negative peak values Vd⁺ and Vd⁻ is Vdₘ.

In the first horizontal synchronizing periods T_{HSYN}, the output of the shift register/latch circuit 141 is reset at the time t2 prior to the time t3. Therefore, the value of the data, voltage gradually decreases to its middle point voltage Vₘ. At the time t2, the pulse of the gate voltage (i.e., the selection voltage supplied from the gate driver circuit 13) falls. The rise of the pulse of the gate voltage occurs at the time t1, which means that the rise of the gate voltage is synchronized with the fall of the latch signal STB. As seen from FIG. 7, the period from t1 to t2 is the writing period T_{WR} while the period from t2 to t4 is the blanking period T_{B}. In this way, the resetting operation is carried out in the blanking period T_{B}.

The resetting circuit 142 is controlled in such a way that each of the data voltages will reach the middle point value V⁻ between the positive peak value V⁺ and the negative peak value V³¹ after the resetting operation is completed. Here, the middle point value Vₘ is equal to the common voltage of the common electrode 24.

Therefore, the data voltage applied to each of the corresponding pixels PX by the source driver circuit 14 in each of the horizontal synchronizing periods (=2T_{HSYN}) is uniformized in the rising state by the resetting operation. This means that the total amount of the charge written into the pixels PX (i.e., the area of the hatched part in FIG. 7) in the first one of the two horizontal synchronizing periods (=2T_{HSYN}) of every polarization inversion period can be equalized to that of the charge written into the pixels PX in the second one of the same horizontal synchronizing periods.

As a result, the unwanted horizontal stripes, which are caused by the luminance difference between the first and second horizontal synchronizing periods of every polarization inversion period, are prevented.

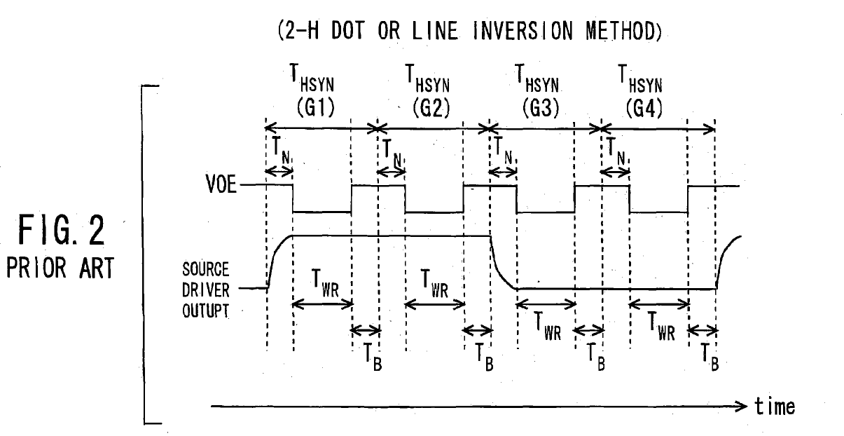

Furthermore, unlike the prior-art method of FIG. 2, the writing period T_{WR} is not shortened by addition of the non-writing period T_{N}. Therefore, the luminance is not decreased.

In addition, since the unwanted horizontal stripes are prevented by resetting the data voltages outputted by the source driver circuit 14 in the blanking period T_{B} of each of the horizontal synchronizing periods (=2T_{HSYN}), the frequency or possibility of flicker itself is reduced. Thus, flicker is rarely observed even when the backlight intensity is high.

In the above-described first embodiment, the resetting operation by the resetting circuit 142 is synchronized with the fall of the gate voltage at the time t2. However, the invention is not limited to this. The resetting operation may be performed with reference to the latch signal STB. In other words, the resetting operation may be synchronized with the rise of the latch signal STB, or it may be performed after the rise or fall of the latch signal STB by a fixed delay time.

In addition, the LCD device of the first embodiment has additional advantages as follows.

(i) The power consumption is decreased compared with the prior-art device driven by the 1-H inversion method without using the resetting operation.

(ii) The power consumption is approximately the same as that of the prior-art device driven by the 2-H inversion method without using the resetting operation.

### Second Embodiment

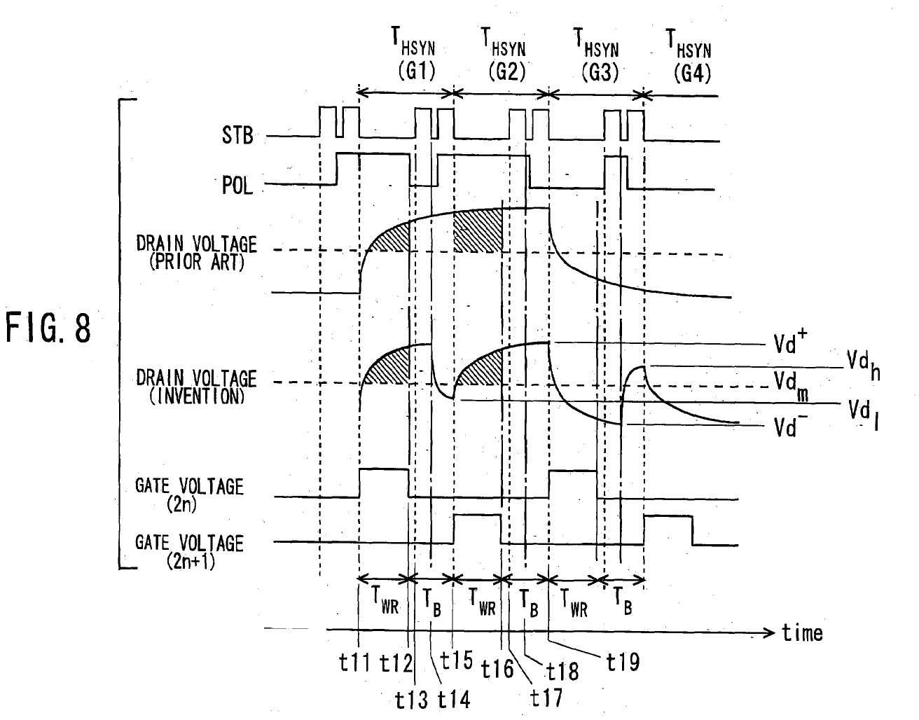

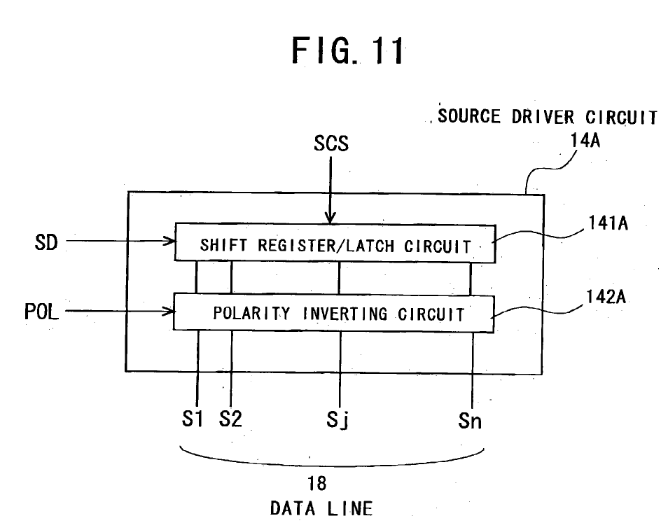

Next, an active-matrix addressing LCD device according to a second embodiment of the invention will be explained below with reference to FIGS. 8 and 11.

The device of the second embodiment has the same circuit configuration and operation as those of the device of the first embodiment, except that a source driver circuit 14A has a polarity inverting circuit 142A for inverting the polarity of the data voltages outputted by a shift register/latch circuit 141A, instead of the resetting circuit 141. Therefore, the explanation about the same configuration and operation is omitted here for the sake of simplification.

FIG. 11 schematically shows the circuit configuration of the source driver circuit 14A. As seen from FIG. 11, the circuit 14A has a shift register/latch circuit 141A and a polarity inverting circuit 142A.

The shift register latch circuit 141A has the same functions as those of the shift register/latch circuit 141 in the first embodiment. Therefore, no explanation about this circuit 141A is omitted here.

The polarity inverting circuit 142A has a function of inverting the polarity of the data voltages to be outputted by the source driver circuit 14A in the blanking period of each horizontal synchronizing period in the polarity inversion period (i.e., the set of the two horizontal synchronizing periods).

The polarity inverting operation of the polarity inverting circuit 142A can be easily realized by applying the polarity inversion signal POL to the data voltages at proper timing. Since the polarity inversion signal POL is generated to repeatedly invert the polarity of the data voltages within every two adjoining frame periods, no additional circuit is necessary to cause the polarity inverting operation.

Next, the operation of the LCD device according to the second embodiment is explained in detail below with reference to FIGS. 8 and 9.

In FIG. 8, at the last falling edge t11 of the twin pulse of the latch signal STB in the first horizontal synchronizing period T_{HSYN} for the scanning line G1, the latching operation of the shift register/latch circuit 141A is ended. Thus, the image data stored in the circuit 141A are supplied to the respective pixels PX by way of the data lines 18 (S1 to Sn). As a result, each of the output voltages of the source driver circuit 14A and the drain voltage of-each TFT 15 start to increase gradually.

Thereafter, the latching operation is started at the first rising edge t13 of the twin pulse of the signal STB. This means that the image data in the circuit 141A is supplied to the pixels PX within the period from the time t11 to the time t13 in which the signal STB is kept in its low level (L). As a result, each of the output voltages of the source driver circuit 14 and the drain voltage of each TFT 15 increase gradually in the period from t11 to t13.

Subsequently, the latching operation thus started is stopped at the second falling edge t15 of the twin pulse of the signal. This means that the, image data in the shift register/latch circuit 141A is latched within the period from the time t13 to the time t15.

Similarly, at the second falling edge t15 of the twin pulse of the latch signal STB in, the second horizontal synchronizing period T_{HSYN} for the scanning line G2, the latching operation of the shift register/latch circuit 141A is ended. Thus, the image data stored in the circuit 141A are supplied to the respective pixels PX by way of the data lines 18 (S1 to Sn). Thereafter, the latching operation is started again at the next rising edge t17 of the signal STB and then, ended at the next falling edge t19 thereof.

The same operation as above is repeated in the third and fourth horizontal synchronizing periods T_{HSYN} for the gate or scanning lines G3, and G4, respectively.

Similar to the first embodiment, the data voltage outputted from the source driver circuit 14A has alternately a positive peak value V⁺ or a negative peak value V⁻ in every polarity inversion period (i.e., every set of the two horizontal synchronizing periods (=2T_{HSYN}), as shown in FIG. 9. The middle point value between the positive and negative peak values V⁺ and V⁻ is Vₘ. As a result, the drain voltage of the TFT 15, which is generated by the data voltage from the circuit 14A, has alternately a positive peak value Vd⁺ or a negative peak value Vd⁻0 in every polarity inversion period, as shown in FIG. 8. The middle point value between the positive and negative peak values Vd⁺ and Vd⁻ is Vdₘ.

In the first horizontal synchronizing periods T_{HSYN}, the output of the shift register/latch circuit 141A is polarity-inverted at the time t14 prior to the time t15. Therefore, the value of the data voltage gradually decreases from the positive peak value Vd⁺ to a negative voltage value Vd₁. At the time t12, the pulse of the gate voltage (i.e., the selection voltage supplied from the gate driver circuit 13) falls. The rise of the pulse of the gate voltage occurs at the time t11, which means that the rise of the gate voltage is synchronized with the second fall of the latch signal STB. As seen from FIG. 8, the period from t11 to t12 is the writing period T_{WR} while the period from t12 to t15 is the blanking period T_{B}. Thus, the polarity inversion operation is carried out in the blanking period T_{B}.

The polarity inverting circuit 142A is controlled in such a way that each of the data voltages will reach the opposite-polarity value Vdₕ or Vd₁ across the middle point line of Vdₘ after the polarity inversion operation is completed. Here, the middle point value Vₘ is equal to the common voltage of the common electrode 24.

Therefore, the data voltage applied to each of the corresponding pixels PX by the source driver circuit 14A in each of the horizontal synchronizing periods (=2T_{HSYN}) is uniformized in the rising state by the polarity inverting operation. This means that the total amount of the charge written into the pixels PX (i.e., the area of the hatched part in FIG. 8) in the first one of the two horizontal synchronizing periods (=2T_{HSYN}) of every polarization inversion period can be equalized to that of the charge written into the pixels PX in the second one of the same horizontal synchronizing periods.

As a result, the unwanted horizontal stripes, which are caused by the luminance difference between the first and second horizontal synchronizing periods of every polarization inversion period, are prevented.

Furthermore, unlike the prior-art method of FIG. 2, the writing period T_{WR} is not shortened by addition of the non-writing period T_{N}. Therefore, the luminance is not decreased.

In addition, since the unwanted horizontal stripes are prevented by polarization-inverting the data voltages outputted by the source driver circuit 14A in the blanking period T_{B} of each of the horizontal synchronizing periods (=2T_{HSYN}), the frequency or possibility of flicker itself is reduced. Thus, flicker is rarely observed even when the backlight intensity is high.

### Other Embodiments

It is needless to say that the invention is not limited to the above-described first and second embodiments. Any modification is applicable to these embodiments. For example, although the LCD device is driven according to the 2-H dot or line inversion method in the above-described embodiments, the device may be driven according to the 3-H, 4-H, . . . , or k-H dot or line inversion method, where k≧3. The polarity-inverting signal POL applied to the polarity inverting circuit 142A may be separately generated by an additional circuit.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. An active-matrix addressing LCD device comprising:
a panel including an active-matrix substrate, an opposite substrate, and a liquid crystal layer sandwiched by the active-matrix substrate and the opposite substrate;
the active-matrix substrate having data lines, scanning lines that intersect with the data lines at intersections, pixels arranged near the respective intersections, and TFTs arranged as switching elements for the respective pixels;
a source driver circuit for driving the data lines;
a gate driver circuit for driving the scanning lines; and
a controller circuit for controlling the source: driver and the gate driver;
wherein a polarity of a data voltage applied to each of the pixels by way of a corresponding one of the data lines and a corresponding one of the TFTs is inverted in every set of two or more horizontal synchronizing periods by the controller circuit;
and wherein the source driver has a resetting means for resetting the data voltages outputted by the source driver circuit in a blanking period of each of the horizontal synchronizing periods of the set.

2. The device according to claim 1, wherein the resetting means performs its resetting operation with reference to a latch signal supplied to the source driver circuit by the controller circuit.

3. The device according to claim 1, wherein each of the data voltages alternately has a positive value or a negative value in the polarity inversion period;
and wherein the resetting means is controlled in such a way that each of the data voltages will reach a middle point value between the positive value and the negative value after the resetting operation is completed.

4. The device according to claim 1, wherein the polarity of the data voltages supplied by way of the data lines is alternately inverted in every set of the two horizontal synchronizing periods and in every vertical synchronizing period within every frame period, thereby driving the device by a 2-H dot inversion method.

5. The device according to claim 1, wherein the polarity of the data voltages supplied by way of the data lines is alternately inverted in every set of the two horizontal synchronizing periods within every frame period, thereby driving the device by a 2-H line inversion method.

6. An active-matrix addressing LCD device comprising:
a panel including an active-matrix substrate, an opposite substrate, and a liquid crystal layer sandwiched by the active-matrix substrate and the opposite substrate;
the active-matrix substrate having data lines, gate lines that intersect with the data lines at intersections, pixels arranged near the respective intersections, and TFTs arranged as switching elements for the respective pixels;
a source driver circuit for driving the data lines;
a gate driver circuit for driving the scanning lines; and
a controller circuit for controlling the source driver and the gate driver;
wherein a polarity of a data voltage applied to each of the pixels by way of a corresponding one of the data lines and a corresponding one of the, TFTs is inverted in every set of two or more horizontal synchronizing periods by the controller circuit;
and wherein the source driver has a polarity inverting means for inverting the polarity of the data voltages outputted by the source driver circuit in a blanking period of each of the horizontal synchronizing periods of the set.

7. The device according to claim 6, wherein the polarity inverting means performs its polarity-inverting operation with reference to a latch signal and a polarity-inverting signal, which are supplied to the source driver circuit by the controller circuit.

8. The device according to claim 6, wherein the polarity inverting means is controlled in such a way that each of the data voltages will reach a value of an opposite polarity after the polarity-inverting operation is completed.

9. The device according to claim 6, wherein the polarity of the data voltages supplied by way of the data lines is alternately inverted in every set of the two horizontal synchronizing periods and in every vertical synchronizing period within every frame period, thereby driving the device by a 2-H dot inversion method.

10. The device according to claim 6, wherein the polarity of the data voltages supplied by way of the data lines is alternately inverted in every set of the two horizontal synchronizing periods within every frame period, thereby driving the device by a 2-H line inversion method.

11. A method of driving an active-matrix addressing LCD device, the device comprising:
a panel including an active-matrix substrate, an opposite substrate, and a liquid crystal layer sandwiched by the active-matrix substrate and the opposite substrate;
the active-matrix substrate having data lines, scanning lines that intersect with the data lines at intersections, pixels arranged near the respective intersections, and TFTs arranged as switching elements for the respective pixels;
a source driver circuit for driving the data lines;
a gate driver circuit for driving the scanning lines; and
a controller circuit for controlling the source driver and the gate driver;
the method comprising:
inverting a polarity of a data voltage applied to each of the pixels by way of a corresponding one of the data lines and a corresponding one of the TFTs in every set of two or more horizontal synchronizing periods; and
resetting the data voltages outputted by the source driver circuit in a blanking period of each of the horizontal synchronizing periods of the set.

12. The method according to claim 11, wherein an operation of the resetting the data voltages is performed with reference to a latch signal supplied to the source driver circuit by the controller circuit.

13. The method according to claim 11, wherein each of the data voltages alternately has a positive value or a negative value in the polarity inversion period;
and wherein an operation of the resetting the data voltages is performed in such a way that each of the data voltages will reach a middle point value between the positive value and the negative value after the resetting operation is completed.

14. The method according to claim 11, wherein the polarity of the data voltages supplied by way of the data lines is alternately inverted in every set of the two horizontal synchronizing periods and in every vertical synchronizing period within every frame, period, thereby driving the device by a 2-H dot inversion method.

15. The method according to claim 11, wherein the polarity of the data voltages supplied by way of the data lines is alternately inverted in every set of the two horizontal synchronizing periods within every frame period, thereby driving the device by a 2-H line inversion method.

16. A method of driving an active-matrix addressing LCD device, the device comprising:
a panel including an active-matrix substrate, an opposite substrate, and a liquid crystal layer sandwiched by the active-matrix substrate and the opposite substrate;
the active-matrix substrate having data lines, scanning lines that intersect with the data lines at intersections, pixels arranged near the respective intersections, and TFTs arranged as switching elements for the respective pixels;
a source driver circuit for driving the data lines;
a gate driver circuit for driving the scanning lines; and
a controller circuit for controlling the source driver and the gate driver;
the method comprising:
inverting a polarity of a data voltage applied to each of the pixels by way of a corresponding one of the data lines and a corresponding one of the TFTs, in every set of two or more horizontal synchronizing periods; and
inverting the polarity of the data voltages outputted by the source driver circuit in a blanking period of each of the horizontal synchronizing periods of the set.

17. The method according to claim 16, wherein an operation of inverting the polarity of the data voltages is performed with reference to a latch signal and a polarity-inverting signal, which are supplied to the source driver circuit by the controller circuit.

18. The method according to claim 16, wherein an operation of inverting the polarity of the data voltages is performed in such a way that each of the data voltages will reach a value of an opposite polarity after the polarity-inverting operation is completed.

19. The method according to claim 16, wherein the polarity of the data voltages supplied by way of the data lines is alternately inverted in every set of the two horizontal synchronizing periods and in every vertical synchronizing period within every frame period, thereby driving the device by a 2-H dot inversion method.

20. The method according to claim 16, wherein the polarity of the data voltages supplied by way of the data lines is alternately inverted in every set of the two horizontal synchronizing periods within every frame period, thereby driving the device by a 2-H line inversion method.
